(19) United States
(12) Patent Application Publication
(10) Pub. No.: US 2012/0207984 A1
(43) Pub. Date: Aug. 16, 2012

(54) INKJET INK, METHOD FOR PREPARING SAME, INK CARTRIDGE CONTAINING SAME, IMAGE FORMING METHOD AND APPARATUS USING SAME, AND PRINT FORMED BY THE IMAGE FORMING METHOD

(76) Inventors: Shin HASEGAWA, Shizuoka (JP); Hiroyuki FUSHIMI, Shizuoka (JP)

(21) Appl. No.: 13/360,949

(22) Filed: Jan. 30, 2012

(30) Foreign Application Priority Data
Feb. 14, 2011 (JP) 2011-028786

(51) Int. Cl. B32B 3/00; B41J 2/01; B41J 2/175; C09D 11/02; C08K 3/04

(52) U.S. Cl. 428/195.1; 106/31.9; 106/31.89; 524/496; 347/86; 347/100

(57) ABSTRACT

The inkjet ink includes a carbon black, a surfactant, water, and a water soluble organic solvent. The carbon black has a residue on sieve of from 0.1 ppm to 50 ppm, which is determined based on DIN ISO 787/18, and a statistical thickness surface area (STSA) of from 70 m²/g to 90 m²/g.

### CROSS-REFERENCE TO RELATED APPLICATIONS

This patent application is based on and claims priority pursuant to 35 U.S.C. §119 to Japanese Patent Application No. 2011-28786, filed on Feb. 14, 2011 in the Japan Patent Office, the entire disclosure of which is hereby incorporated herein by reference.

### FIELD OF THE INVENTION

The present invention relates to an inkjet ink. In addition, the present invention also relates to a method for preparing the inkjet ink, an ink cartridge containing the inkjet ink, an image forming method and apparatus using the inkjet ink, and a print formed by the image forming method.

### BACKGROUND OF THE INVENTION

Inkjet image forming methods have advantages over other image forming methods such that the process is simple, full color images can be produced relatively easily, and high resolution images can be produced by using an inkjet recording device having a simple structure.

Dye-based inks, in which a water soluble dye is dissolved in a solvent such as water and mixture solvents of water and an organic solvent, have been typically used as inkjet inks. Such dye-based inks have an advantage such that the colors of images produced by the inks are clear, but have a drawback such that the light resistance of images is bad. In contrast, since pigment-based inks, in which a pigment such as carbon black and organic pigments is dispersed in a medium, have better light resistance than dye-based inks, pigment-based inks have been investigated with enthusiasm. However, pigment-based inks have a drawback such that a nozzle clogging problem in that an inkjet nozzle is clogged with ink is caused relatively easily compared to dye-based inks.

When preparing a pigment-based ink, a raw material of the pigment, which is typically an aggregate of the pigment, is ground and dispersed in a dispersion medium so as to be primary particles or the like particles of the pigment to prepare a pigment dispersion for the ink. Specifically, a pigment-based ink is typically prepared by a method such that a pigment and a dispersion medium are mixed, and the mixture is subjected to a dispersing/grinding treatment by a dispersing device using a media such as ball mills and sand mills. The media used for such a dispersing device is typically beads of glass, iron and ceramics with a diameter of from 1 mm to a few millimeters. In this regard, when the diameter of the media decreases, the number of beads in a unit volume increases at an exponential rate, thereby dramatically increasing the number of collision of particles of the pigment with beads, resulting in formation of a pigment dispersion in which fine particles of the pigment are dispersed in the dispersion medium.

In attempting to improve the preservability of a pigment dispersion, the image density of images produced by an ink including the pigment dispersion, and the ejection property of the ink, various proposals have been made. For example, there is a proposal for a pigment ink using carbon black as a pigment, which concerns the physical properties of the carbon black such as percentage of residue on sieve (hereinafter referred to as residue on sieve), oil absorption, and BET specific surface area and which concerns the dispersant used for dispersing the carbon black in a dispersion medium. In addition, there is a proposal for a pigment ink using carbon black, which concerns the content of volatile components included in the carbon black and which specifies the water-insoluble polymer included in the ink. Further, there is a proposal for a pigment ink using carbon black, which uses a polyaromatic hydrocarbon (PAH) and which specifies the carbon black and the oil absorption of the carbon black. Furthermore, there is a proposal for a pigment ink using carbon black, which concerns the method for preparing the ink, the dispersant for the carbon black, and the physical properties of the carbon black such as BET specific surface area and primary particle diameter.

However, these pigment inks do not necessarily have a good combination of the preservability, image density, and ink ejection property.

For these reasons, the inventors recognized that there is a need for an inkjet ink which has a good combination of preservability and ejection property and which can produce images with high image density.

### BRIEF SUMMARY OF THE INVENTION

As an aspect of the present invention, an inkjet ink is provided which includes at least a carbon black, a surfactant, water and a water soluble organic solvent, wherein the carbon black has a residue on sieve of from 0.1 ppm to 50 ppm which is determined based on DIN ISO 787/18, and a statistical thickness surface area (STSA) of from 70 m²/g to 90 m²/g.

As another aspect of the present invention, a method for preparing the inkjet ink mentioned above is provided which includes mixing at least the carbon black, the surfactant, and water to prepare a mixture having a viscosity of from 5 mPa·s to 15 mPa·s; subjecting the mixture to a dispersing treatment using a media-mill to prepare a carbon black dispersion having a viscosity of from 1.5 mPa·s to 2.5 mPa·s; and mixing the carbon black and the water-soluble organic solvent.

As yet another aspect of the present invention, an ink cartridge is provided which includes the inkjet ink mentioned above, and a container containing the inkjet ink therein.

As a further aspect of the present invention, an image forming apparatus is provided which includes the ink cartridge mentioned above, and a recording head to eject droplets of the inkjet ink included in the ink cartridge toward a recording material to form an image on the recording material

As a still further aspect of the present invention, an image forming method is provided which includes ejecting droplets of the inkjet ink mentioned above toward a recording material to form an image on the recording material.

As a still further aspect of the present invention, a print is provided which includes a support and an ink image formed on the support by the image forming method mentioned above.

The aforementioned and other aspects, features and advantages will become apparent upon consideration of the following description of the preferred embodiments taken in conjunction with the accompanying drawings.

### BRIEF DESCRIPTION OF THE SEVERAL VIEWS OF THE DRAWINGS

FIG. 1 is a schematic view illustrating an example of the ink cartridge of the present invention;

FIG. 2 is a schematic view illustrating an example of the image forming apparatus of the present invention; and

FIG. 3 is a schematic view illustrating a recording head of the image forming apparatus illustrated in FIG. 2.

### DETAILED DESCRIPTION OF THE INVENTION

Initially, the inkjet ink of the present invention will be described.

The inkjet ink of the present invention (hereinafter sometimes referred to as ink) includes at least a carbon black, a surfactant, water, and a water-soluble organic solvent. In this regard, the carbon black has a residue on sieve of from 0.1 ppm to 50 ppm which is determined based on DIN ISO 787/18, and a statistical thickness surface area (STSA) of from 70 m²/g to 90 m²/g.

The residue on sieve is a measure of the amount of impurities such as coke and tar included in the carbon black, and it is difficult to disperse a carbon black including coke and tar in a large amount in a dispersion medium including water and an organic solvent. In addition, an ink including such a carbon black has poor preservability.

As a result of the present inventors' investigation, it is found that the residue on sieve of carbon black used for an ink is preferably as small as possible, but it is not preferable that the residue on sieve is 0. Specifically, when the residue on sieve of a carbon black used for an ink is less than about 0.1 ppm, the image density of images produced by the ink decreases. The reason therefor is considered to be that the coke and tar included in carbon black has a function of increasing image density. In addition, when the residue on sieve is less than about 0.1 ppm, the ejection property of the ink tends to deteriorate.

According to the investigation by the present inventors, the residue on sieve of a carbon black used for the ink of the present invention is preferably from 0.1 ppm to 50 ppm (on a weight basis), more preferably from 0.1 ppm to 25 ppm, and even more preferably from 0.1 ppm to 10 ppm. When the residue on sieve is greater than 50 ppm, the content of coarse particles of the carbon black in the resultant pigment dispersion increases, thereby broadening the particle diameter distribution of the pigment in the pigment dispersion and deteriorating the filtering property of the pigment dispersion.

The statistical thickness surface area (STSA, i.e., outer specific surface area) of the carbon black used for the ink of the present invention is preferably from 70 m²/g to 90 m²/g, more preferably from 72 m²/g to 88 m²/g, and even more preferably from 74 m²/g to 86 m²/g. When the statistical surface area of the carbon black used for the ink is less than 70 m²/g, the image density of images produced by the ink tends to decrease. In contrast, when the STSA is greater than 90 m²/g, it is necessary to use a large amount of dispersant for dispersing the carbon black in a dispersion medium. In other words, it becomes hard to prepare a pigment dispersion having a low viscosity. In addition, when the STSA is greater than 90 m²/g, the preservability of the resultant ink tends to deteriorate.

Such carbon blacks having a residue on sieve and a STSA in the above-mentioned ranges can be preferably prepared by methods such as channel methods, e.g., High Color Channel methods, Medium Color Channel methods, and Regular Color Channel methods; and gas black methods. Specific examples of commercialized carbon blacks include MONARCH 1000 series, REGAL 400R series, and MOGUL L, which are from Cabot Corp.; SPECIAL BLACKs 550, 350, 250, and 100 series, COLOR BLACKs 5170, S160, 5, 4, 150T, 140U, U, and V series, and NIPEXs 150, 160IQ, 170IQ, and 180IQ, which are from Degussa A.G.; #2350, #2200B, #1000, and #970 series, which are from Mitsubishi Chemical Corp.; etc.

Among these commercialized carbon blacks, NIPEXs 150, 160IQ, 170IQ, and 180IQ from Degussa A.G. are preferable because the resultant pigment dispersion has good dispersion stability.

The surfactant included in the ink of the present invention is not particularly limited, and one or more proper surfactants can be used in consideration of the property of the carbon black used as a pigment.

Suitable materials for use as the surfactant include anionic surfactants, nonionic surfactants, and polymeric surfactants. The added amount of the surfactant is from 0.01 parts to 0.5 parts by weight, and more preferably from 0.25 parts to 0.5 parts by weight, based on 1 part by weight of the carbon black used.

Specific examples of the anionic surfactants include salts of alkylsulfonic acids, salts of alkylbenzenesulfonic acids, salts of alkylnaphthalenesulfonic acids, sodium salts of formalin condensates of naphthalenesulfonic acid, salts of alkane- or olefin-sulfonic acids, esters of alkylsulfuric acids, ester salts of polyoxyethylenealkyl- or alkylarylether-sulfuric acids, salts of alkylphosphoric acids, salts of alkyldiphenyletherdisulfonic acids, ether carboxylates, salts of alkylsulfosuccinic acids, esters of α-sulfofatty acids, salts of fatty acids, and the like. In addition, condensates of a higher fatty acid and an amino acid, salts of naphthenic acids, and the like can also be used as the surfactant.

The salts of aromatic sulfonic acids mentioned above are typically prepared by a method in which an aromatic compound, to which a sulfonic acid group is introduced, is neutralized with a basic compound. Specific examples of the aromatic compound having a sulfonic acid group include benzenesulfonic acid, p-toluenesulfonic acid, naphthalenesulfonic acid, alkylnaphthalenesulfonic acids, and the like. Specific examples of the basic compound include alkylamines such as butylamine and triethylamine, alkanolamines such as monoethanolamine, diethanolamine, triethanolamine and triisopropanolamine, morphorine, ammonia water, sodium hydroxide, lithium hydroxide, potassium hydroxide, aminomethylpropanediol, corrin, and the like. In addition, buffers such as trishydroxymethylaminomethane, and Good buffers can also be used as the basic compound.

Among these surfactants, sodium salts of formalin condensates of naphthalenesulfonic acid are preferably used because the surfactants can satisfactorily disperse carbon black and the resultant ink hardly forms bubbles. In this regard, the total contents of dimers, trimers and tetramers of naphthalenesulfonic acid in the formalin condensate of naphthalenesulfonic acid is preferably from 20% to 80% by weight based on the weight of the condensate of naphthalenesulfonic acid. When the total content of dimers, trimers and tetramers is less than 20% by weight, the dispersibility of carbon black deteriorates, and therefore the preservability of the resultant pigment dispersion and ink deteriorates, thereby easily causing the nozzle clogging problem mentioned above. In contrast, when the content is greater than 80% by weight, the viscosity of the mixture of ink components seriously increases, thereby making it difficult to prepare a pigment dispersion in which carbon black is satisfactorily dispersed.

Specific examples of the nonionic surfactants include polyoxyethylene alkyl ethers such as polyoxyethylene lauryl ether, polyoxyethylene myristyl ether, polyoxyethylene cetyl ether, polyoxyethylene stearyl ether, and polyoxyethylene oleyl ether; polyoxyethylene alkylphenyl ethers such as polyoxyethylene octylphenyl ether, and polyoxyethylene nonylphenyl ether; polyoxyethylene α-naphthyl ether, polyoxyethylene β-naphthyl ether, polyoxyethylene monostyrylphenyl ether, polyoxyethylene distyrylphenyl ether, polyoxyethylene alkylnaphthyl ethers, polyoxyethylene monostyrylnaphthyl ether, polyoxyethylene distyrylnaphthyl ether, polyoxyethylene polyoxypropylene block copolymers, and the like.

Among these nonionic surfactants, polyoxyethylene styrylphenyl ethers such as polyoxyethylene monostyrylphenyl ether, and polyoxyethylene distyrylphenyl ether are preferable because the surfactants can satisfactorily disperse carbon black and the resultant ink hardly forms bubbles.

Specific examples of the polymeric surfactants include styrene-acrylic acid-alkyl acrylate copolymers, styrene-acrylic acid copolymers, styrene-maleic acid-alkyl acrylate copolymers, styrene-maleic acid copolymers, styrene-methacrylic acid-alkyl acrylate copolymers, styrene-methacrylic acid copolymers, styrene-half ester of maleic acid copolymers, vinyl naphthalene-acrylic acid copolymers, vinyl naphthalene-maleic acid copolymers, polyacrylic acid, polycarboxylic acids, polycarboxylic acid graft polymers, and the like. Among these polymeric surfactants, polyacrylic acid, polycarboxylic acids, styrene-acrylic acid copolymers, and polycarboxylic acid graft polymers are preferable because the surfactants can satisfactorily disperse carbon black and the resultant ink images have good resistance to solvents.

The molecular weight of the polycarboxylic acid graft polymers is preferably from 5,000 to 20,000, and more preferably from 10,000 to 15,000. When the molecular weight is less than 5,000, carbon black is not satisfactorily dispersed, and therefore the preservability of the resultant pigment dispersion and ink tends to deteriorate, thereby easily causing the nozzle clogging problem mentioned above. In contrast, when the molecular weight is greater than 20,000, the viscosity of the mixture of ink components seriously increases, thereby making it difficult to prepare a pigment dispersion in which carbon black is satisfactorily dispersed.

Specific examples of the polycarboxylic acid graft polymers include multi-component polycarboxylic acid copolymers having the following formula (1) and polycarboxylic acid ethers having the following formula (2).

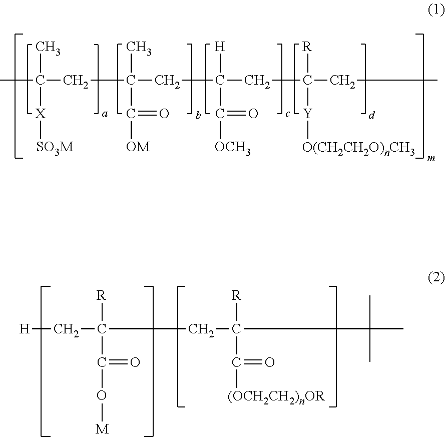

In formula (1), R represents a hydrogen atom or a methyl group; Y represents —CH₂—, or —CO—; X represents —CH₂—, or —CH₂OPh- (Ph represents a phenyl group); M represents an alkali metal, an alkali earth metal, an ammonium group, or an organic amine group; and each of a, b, c, d, and m is 0 or a positive integer, wherein a+b+c+d<50.

In formula (2), R represents a hydrogen atom or a methyl group; M represents an alkali metal, an alkali earth metal, an ammonium group, or an organic amine group; and n is a positive integer.

Specific examples of the water-soluble organic solvents included in the ink of the present invention include polyalcohols such as ethylene glycol, diethylene glycol, triethylene glycol, polyethylene glycol, polypropylene glycol, 1,3-butanediol, 3-methyl-1,3-butanediol, 1,5-pentanediol, 1,6-hexanediol, 2-ethyl-1,3-hexanediol, glycerin, 1,2,3-butanetriol, 1,2,4-butanetriol, 1,2,6-hexanetriol, and petriol; polyalcohol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; polyalcohol aryl ethers such as ethylene glycol monophenyl ether, and ethylene glycol monobenzyl ether; nitrogen-containing heterocyclic compounds such as 2-pyrrolidone, N-methyl-2-pyrrolidone, N-hydroxyethyl-2-pyrrolidone, 1,3-dimethylimidazolidinone, ε-caprolactam, and γ-butyrolactone; amides such as formamide, N-methylformamide, and N,N-dimethylformamide; amines such as monoethanolamine, diethanolamine, triethanolamine, monoethylamine, diethylamine, and triethylamine; sulfur-containing compounds such as dimethylsulfoxide, sulfolane, and thiodiethanol; propylene carbonate, ethylene carbonate, etc.

Among these water-soluble organic solvents, diethylene glycol, triethylene glycol, 1,3-butanediol, and glycerin are preferable because of effectively preventing drying of the ink due to evaporation of water in the ink, thereby preventing occurrence of the nozzle clogging problem (i.e., preventing deterioration of ejection property of the ink), while producing high density images.

The added amount of a water-soluble organic solvent in the ink of the present invention is preferably not greater than 50% by weight, more preferably from 5% to 40% by weight, and even more preferably from 10% to 35% by weight, based on the weight of the ink.

The inkjet ink of the present invention preferably includes 2-ethyl-1,3-hexanediol (hereinafter referred to as EHD) to enhance the permeability of the ink while retaining the pigment included in the ink on the surface of a recording material, thereby forming images without blurring. In addition, addition of EHD enhances the ejection property of the ink, and prevents occurrence of a problem in that the ink penetrates to the backside of a recording paper, while producing high density images.

The added amount of EHD in the ink is preferably from 0.1% to 10.0% by weight, and more preferably from 1.5% to 5.0% by weight, based on the weight of the ink. When the added amount of EHD is less than 0.1% by weight, the above-mentioned effects are hardly produced. In contrast, when the added amount is greater than 10.0% by weight, the reliability of the ink deteriorates because EHD is not satisfactorily solved in the ink.

The inkjet ink of the present invention preferably includes an aqueous resin dispersion, particularly an aqueous polyurethane resin dispersion. The polyurethane resin is not particularly limited, and a proper polyurethane resin is used so that the resultant ink has the desired properties.

In this regard, polyurethane resins are defined as resins having a polyurethane chain having series of a urethane bond, which is formed by reaction of a diisocyanate compound with a diol compound. Aqueous polyurethane resin dispersions are typically prepared by incorporating a hydrophilic group into the polyurethane chain so that the resultant polyurethane resin can be stably dispersed in water. Alternatively, it is possible to disperse a polyurethane resin in water using an external emulsifier to prepare a polyurethane resin emulsion. Among these aqueous polyurethane resin dispersions, dispersions of self-dispersing polyurethane resins (i.e., emulsions of self-emulsifying polyurethane resins), in which a hydrophilic group is incorporated into the main chain thereof, are preferable.

Self-emulsifying polyurethane resins for use in the inkjet ink of the present invention are not particularly limited, and a proper self-emulsifying polyurethane resin is used so that the resultant ink has the desired properties. For example, self-emulsifying polyurethane resins prepared by reacting (i) a diisocyanate compound, (ii) a diol compound such as polyether diols, polyester diols, and polycarbonate diols, and (iii) another diol having an acid group such as carboxyl groups and sulfonic acid groups are preferable. Specific examples of such self-emulsifying polyurethane resins include ester-based polyurethane resins, ether-based polyurethane resins, and carbonate-based polyurethane resins.

Among these self-emulsifying polyurethane resins, anionic self-emulsifying ether-based polyurethane resin emulsions are preferable. Specific examples of such anionic self-emulsifying ether-based polyurethane resins include resin emulsions disclosed in published unexamined Japanese patent applications Nos. 2009-67907, 2009-173805 (corresponding to US2010309260A1) and 2009-161726 incorporated by reference.

By dispersing carbon black in a dispersion medium including water together with a polyurethane resin, the carbon black can be dispersed more stably in the dispersion medium than in a case where a polyurethane resin is not used. The reason therefor is not yet determined, but is considered to be that the carbon black is covered with the polyurethane, thereby forming a protection colloid, resulting in stabilization of the carbon black dispersion.

The method for synthesizing such aqueous polyurethane resin dispersions (such as emulsions) is not particularly limited, and for example the following methods can be used.

### (1) Method 1

A polyfunctional isocyanate compound, at least one of a compound having two or more active-hydrogen-containing groups capable of reacting with an isocyanate group and a compound having an active-hydrogen-containing group capable of reacting with an isocyanate group, a carboxyl group and a sulfonyl group, and a compound having an active-hydrogen-containing group capable of reacting with an isocyanate group and a cationic group, are mixed such that the isocyanate group is present in an excess amount and reacted in the presence or absence of an organic solvent, to prepare a urethane prepolymer having an isocyanate group at the end of the molecule. Next, at least one of the carboxyl group and sulfonyl group in the urethane prepolymer is neutralized with a neutralizer. The thus neutralized polyurethane prepolymer is fed into water including a polymer chain growing agent so that the polyurethane prepolymer is emulsified and subjected to a polymer chain growing reaction, followed by removal of the organic solvent therefrom if any, resulting in preparation of an aqueous polyurethane resin dispersion.

### (2) Method 2

The urethane prepolymer prepared in the method 1 is fed into water including a neutralizer and a polymer chain growing agent so as to be emulsified and subjected to a polymer chain growing reaction, resulting in preparation of an aqueous polyurethane resin dispersion.

### (3) Method 3

A polymer chain growing agent and water are added to the neutralized urethane prepolymer prepared in the method 1, resulting in preparation of an aqueous polyurethane resin dispersion.

### (4) Method 4

A neutralizer, a polymer chain growing agent and water are added to the urethane prepolymer prepared in the method 1, resulting in preparation of an aqueous polyurethane resin dispersion.

### (5) Method 5

The neutralized urethane prepolymer prepared in the method 1 is fed into water to be emulsified, and then a polymer chain growing agent is added thereto, resulting in preparation of an aqueous polyurethane resin dispersion.

### (6) Method 6

The urethane prepolymer prepared in the method 1 is fed into water including a neutralizer to be neutralized, and then a polymer chain growing agent is added thereto, resulting in preparation of an aqueous polyurethane resin dispersion.

### (7) Method 7

Water is added to the neutralized urethane prepolymer prepared in the method 1, and then a polymer chain growing agent is added thereto, resulting in preparation of an aqueous polyurethane resin dispersion.

### (8) Method 8

Water including a neutralizer is added to the urethane prepolymer prepared in the method 1, and then a polymer chain growing agent is added thereto, resulting in preparation of an aqueous polyurethane resin dispersion.

Commercialized aqueous resin emulsions can be preferably used as the aqueous resin dispersion for the inkjet ink of the present invention. Specific examples of such commercialized aqueous resin emulsions include J-450, J-734, J-7600, J-352, J-390, J-7100, J-741, J-74J, J-511, J-840, J-775, HRC-1645, and HPD-71, which are styrene-acrylic resin emulsions from Johnson Polymer (acquired by BASF); UVA383MA which is an acrylic silicone resin emulsion from BASF; AP4710 which is an acrylic silicone resin emulsion from Showa Highpolymer Co., Ltd.; SF460, SF460S, SF420, SF110, SF300 and SF361, which are polyurethane emulsions from Nippon Unicar Company Limited; W5025 and W5661, which are polyurethane emulsions from Mitsui Chemicals Polyurethanes, Inc.; etc.

The volume average particle diameter (D50) of resin emulsions for use in the inkjet ink of the present invention is preferably not greater than 200 nm, more preferably not greater than 100 nm, and even more preferably not greater than 80 nm. When the volume average particle diameter is not greater than 200 nm, the resultant ink is prevented from causing the nozzle clogging problem, namely good ejection property can be imparted to the ink.

The content of the resin (solid resin), which is included in a resin emulsion, in the ink is preferably from 0.1 to 5% by weight, more preferably from 0.4% to 3% by weight, and even more preferably from 0.4% to 1% by weight, based on the total weight of the ink. When the content is not less than 0.1% by weight, the pigment included in ink droplets adhered to a recording material can be satisfactorily covered with the resin, thereby imparting good abrasion resistance to the ink image. In addition, when the content is not greater than 5% by weight, a good combination of preservability and ejection property can be imparted to the ink.

The inkjet ink of the present invention can optionally include a pH controlling agent, an antiseptic, a fungicide, a chelating agent, an antirust, an antioxidant, an ultraviolet absorbent, an oxygen absorbent, a light stabilizer, and the like.

The pH controlling agent is not particularly limited as long as the agent can control the pH of the ink in a range of from 7 to 11 without deteriorating the properties of the ink. Suitable materials for use as the pH controlling agent include alcohol amines, hydroxides of alkali metals, hydroxides of ammoniums, hydroxides of phosphoniums, carbonates of alkali metals, and the like.

When the pH of the ink is less than 7 or greater than 11, the ink easily dissolves inkjet recording heads and ink supplying members, thereby often causing problems in that the ink is degenerated, the ink leaks from the recording heads and ink supplying members, and deficient ink ejection is caused.

Specific examples of the alcohol amines include diethanolamine, triethanolamine, 2-amino-2-ethyl-1,3-propanediol, and the like.

Specific examples of the hydroxides of alkali metals include lithium hydroxide, sodium hydroxide, potassium hydroxide, and the like.

Specific examples of the hydroxides of ammoniums include ammonium hydroxide, quaternary ammonium hydroxide, and the like.

Specific examples of the hydroxides of phosphoniums include quaternary phosphonium hydroxide, and the like.

Specific examples of the carbonates of alkali metals include lithium carbonate, sodium carbonate, potassium carbonate, and the like.

Specific examples of the antiseptic and fungicide include sodium dehydroacetate, sodium sorbate, sodium 2-pyridinethiol-1-oxide, sodium benzoate, sodium pentachlorophenolate, and the like.

Specific examples of the chelating agent include sodium ethylenediaminetetraacetate, sodium nitrilotriacetate, sodium hydroxyethylethylenediaminetriacetate, sodium diethylenetriaminepentaacetate, sodium uramildiacetate, and the like.

Specific examples of the antirust include acidic sulfites, sodium thiosulfate, ammonium thiodiglycolate, diisopropylammonium nitrite, pentaerythritol tetranitrate, dicyclohexylammonium nitrite, and the like.

Specific examples of the antioxidant include phenol-based antioxidants (including hindered phenol antioxidants), amine-based antioxidants, sulfur-containing antioxidants, phosphorous-containing antioxidants, and the like.

Specific examples of the ultraviolet absorbents include benzophenone-based ultraviolet absorbents, benzotriazol-based ultraviolet absorbents, salicylate-based ultraviolet absorbents, cyanoacrylate-based ultraviolet absorbents, nickel complex-based ultraviolet absorbents, and the like.

The inkjet ink of the present invention can be prepared by any know methods. For example, a method in which a carbon black dispersion, a surfactant, water and a water-soluble organic solvent are mixed while agitated, and coarse particles are removed from the mixture by filtering or centrifugal separation, followed by optional deaeration.

In this regard, the carbon black dispersion used for the ink is preferably prepared by subjecting a mixture including at least a carbon black, a surfactant and water and having a viscosity of from 5 mPa·s to 15 mPa·s to a dispersing treatment using a media-mill so that the resultant dispersion has a viscosity of from 1.5 mPa·s to 2.5 mPa·s, and preferably from 1.75 mPa·s to 2.25 mPa·s. When the viscosity of the mixture is less than 5 mPa·s, volume pulverization of the pigment caused by impact of the media (such as beads) mainly occurs, thereby easily releasing pigment derivatives from the surface of the pigment, resulting in formation of excessively activated pigment surfaces, and therefore the preservability of the resultant ink deteriorates while the productivity of the ink deteriorates. In contrast, when the viscosity of the mixture is greater than 15 mPa·s, friction between the media and the pigment mainly occurs, thereby generating a large amount of heat while needing an excessive power, and therefore it is not preferable in view of stable production of the ink.

The dispersing device for use in preparing the carbon black dispersion is not particularly limited. Specific examples thereof include T.K. FILMIX from PRIMIX, ULTIMIZER from Sugino Machine, CLEAR SSS, and CLEARMIX W MOTION from M Technique, CAVITRON from EUROTECH Ltd., IKA DR2000 from Shinmaru Enterprises, UIP series from Hielscher, SPR from Ostem Co., Ltd., and the like. Among these dispersing devices, devices using ultrasonic waves are preferably used.

When a media-mill is used as the dispersing device, devices using beads are preferably used. Specific examples of such media-mills include TORUSMILL from Getzmann, STAR MILL from Ashizawa Finetech Ltd., VISCOMILL from AIMEX Co., Ltd., DYNO MILL from Shinmaru Enterprises, DIAMOND FINE MILL from Mitsubishi Heavy Industries, Ltd., APEX MEGA from Kotobuki Engineering & Manufacturing Co., Ltd., PICO MILL from Asada Iron Works Co., Ltd., OB BEAD MILL from EUROTECH Ltd., SC MILL from Mitsui Mining Co., Ltd., and the like.

The ink cartridge of the present invention includes a container containing the inkjet ink of the present invention, and can include one or more optional members, if necessary.

The container is not particularly limited, and the form, structure, size and constituent material are properly determined in accordance with the intended use. Specific examples of the container include plastic containers, bags made of an aluminum-laminated film, and the like.

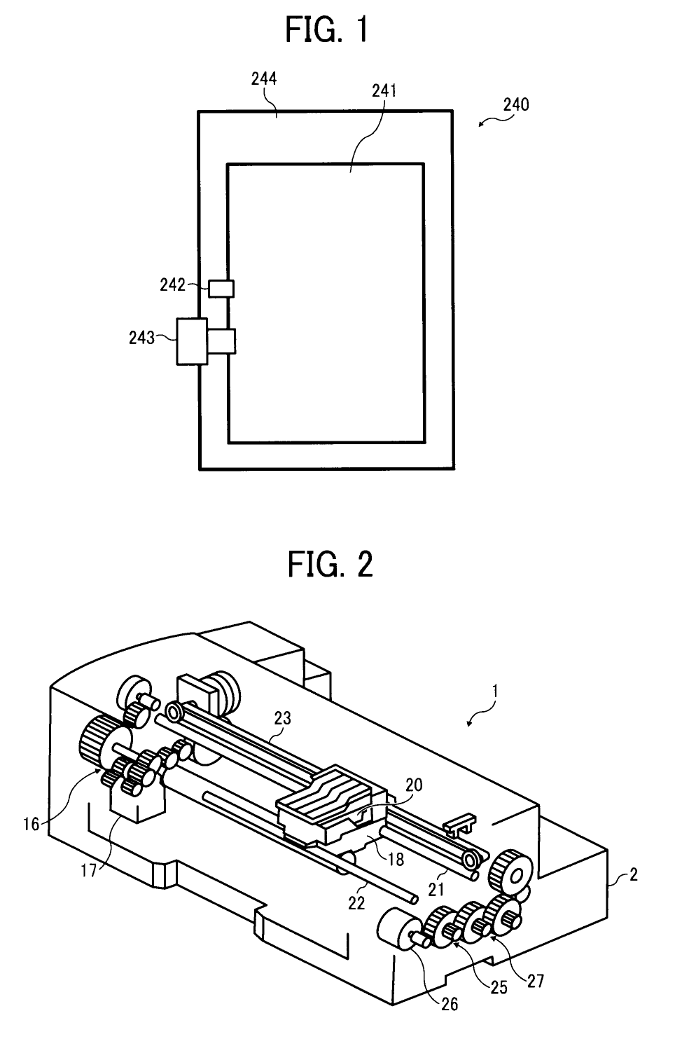

One example of the ink cartridge will be described by reference to FIG. 1.

FIG. 1 is a schematic view illustrating an example of the ink cartridge of the present invention. Referring to FIG. 1, an ink cartridge 240 includes an ink bag 241 serving as a container, an ink inlet 242 from which an ink is fed to the ink bag, an ink outlet 243 from which the ink is discharged, and a cartridge case 244. An ink, which is the inkjet ink of the present invention, is fed into the ink bag 241 from the ink inlet 242. After discharging air from the ink bag 241, the ink inlet 242 is closed by welding or the like. When the ink cartridge 240 is used, the ink bag 11 is set in an inkjet printer so that a needle of the inkjet printer is inserted into the ink outlet 243 of the ink bag 241. The ink bag 241 is contained in the cartridge case 244 typically made of a plastic. The resultant ink cartridge 240 is typically used by being detachably attached to various image forming apparatuses.

The image forming apparatus of the present invention include the above-mentioned ink cartridge and a recording head to eject the ink of the present invention toward a recording material to form an image thereon.

Specific examples of the recording methods include continuous ink ejecting methods, and on demand recording methods such as piezoelectric methods, thermal methods and electrostatic methods.

FIG. 2 illustrates an inkjet recording apparatus 1 as an example of the image forming apparatus of the present invention.

In the inkjet recording apparatus 1 illustrated in FIG. 2, plural ink cartridges 20 each containing a color ink, which is the inkjet ink of the present invention, are set in a carriage 18. Although plural ink cartridges are set in the carriage 18 as illustrated in FIG. 2, the number of the ink cartridges is not particularly limited, and one or more ink cartridges are set in the carriage 18. The color inks in the ink cartridges 20 are supplied to a recording head, which is also set in the carriage 18 and which ejects droplets of the color inks downward from nozzles.

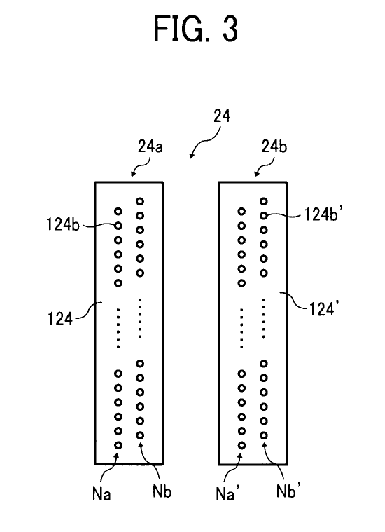

One example of the recording head is illustrated in FIG. 3. As illustrated in FIG. 3, a recording head 24 include a first ink ejecting head 24a and a second ink ejecting head 24b. The first ink ejecting head 24a has a line nozzle 124b including lines of nozzles Na and Nb to eject yellow (Y) ink droplets and magenta (M) ink droplets, respectively, and the second ink ejecting head 24b has another line nozzle 124b′ including lines of nozzles Na′ and Nb′ to eject cyan (C) ink droplets and black (K) ink droplets, respectively.

Specific examples of the first and second liquid ejecting heads 24a and 24b include piezoelectric actuators using a piezoelectric element, thermal actuators utilizing phase change (evaporation) of a liquid film performed by using an electricity-heat conversion element such as resistors, shape-memory-alloy actuators utilizing phase change of a metal caused by temperature change, and electrostatic actuators utilizing electrostatic force.

Referring back to FIG. 2, the recording head 24 set in the carriage 18 is moved in a main scanning direction by a timing belt 23 driven to rotate by a main scanning motor 26 while guided guide shafts 21 and 22.

Meanwhile, a recording material such as coated papers, on which an ink image is to be formed, is fed so as to be located on a platen while facing the recording head. Since the first and second liquid ejecting heads 24a and 24b eject the color inks toward the recording material while moving in the main scanning direction, a strip-shaped color image is formed on the recording material. After the recording material is fed in a predetermined length in a sub-scanning direction perpendicular to the main scanning direction by a sub-scanning motor 17 and a gear mechanism 16, the image forming operation mentioned above is performed again to form another strip-shaped color image on the recording material. By repeating this image forming operation while feeding the recording material in the sub-scanning direction, a full color image is formed on the recording material.

When the ink in the ink cartridge is exhausted, the ink cartridge is replaced with a new ink cartridge.

In FIG. 2, numeral 2 denotes a main body of the inkjet recording apparatus 1, and numerals 25 and 27 denote gear mechanisms.

When an image forming operation is performed using an inkjet recording apparatus containing the inkjet ink of the present invention or the ink cartridge of the present invention, a print, which includes an ink image formed on a support serving as a recording material, is provided.

The recording material is not particularly limited, and a proper recording material is used. Specific examples of the recording material include papers such as plain papers, glossy papers, and special papers, cloths, films, OHP sheets, and the like. Among these recording materials, papers are typically used.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### 1. Preparation of Carbon Black Dispersion No. 1

The following components were mixed using an ultrasonic homogenizer to prepare a mixture having a viscosity of 10 mPa·s.

| | |
|---|---|
| Carbon black A | 200.0 parts |
| (NIPEX 150 from Degussa A.G.) | |
| Surfactant (a) | 50.0 parts |
| (sodium salt of formalin condensate of | |
| naphthalenesulfonic acid, PAIONIN | |
| A-45-PN from Takemoto Oil & Fat | |
| Co., Ltd.) | |
| Distilled water | 750.0 parts |

The mixture was subjected to a dispersing treatment for 15 minutes using a bead mill, UAM-015 from Kotobuki Industries Co., Ltd. The dispersing conditions were as follows.

Beads: Zirconia beads

Diameter of beads: 0.03 mm

Density of beads: 6.03×10⁶ g/m³

Peripheral speed of rotor: 8 m/s

Temperature of the mixture: 30° C.

Thus, a dispersion having a viscosity of 2 mPa·s was prepared. Next, the dispersion was subjected to a centrifugal separation treatment using a centrifugal separator, MODEL 3600 from Kubota Corporation to remove coarse particles from the dispersion. Thus, a carbon black dispersion No. 1 having an average particle diameter of 100 nm was prepared.

The properties of the carbon black A and the surfactant (a) are described later in Tables 2 and 3.

### 2. Preparation of Carbon Black Dispersions Nos. 2-20

The procedure for preparation of the carbon black dispersion No. 1 was repeated except that the carbon black, the surfactant and the weight ratio (S/C) of the surfactant (S) to the carbon black (C) were changed as shown in Table 1 while adjusting the viscosities of the mixture and the dispersion so as to be those described in Table 1. In this regard, the viscosity of the mixture was adjusted by adjusting the time of the premixing operation using the ultrasonic homogenizer, and the viscosity of the dispersion was adjusted by adjusting the dispersing time of the dispersing treatment using the bead mill. As the premixing time and the dispersing time become shorter, the viscosity of the mixture and the dispersion become higher. In addition, the viscosity of the dispersion was adjusted by adjusting the time of the dispersing operation using the bead mill.

Thus, carbon black dispersions Nos. 2-20 were prepared.

The details and the properties of the dispersions Nos. 1-20 are shown in Table 1 below.

TABLE 1

| | | Sur- | | Viscosity | Viscosity |
|---|---|---|---|---|---|
| | Carbon | fac- | | of | of |
| No. of carbon black | black | tant | S/C | mixture | dispersion |
| dispersion | used | used | ratio | (mPa · s) | (mPa · s) |
| No. 1 (for Ex. 1) | A | (a) | 0.25 | 10 | 2 |
| No. 2 (for Ex. 2) | B | (a) | 0.25 | 10 | 2 |
| No. 3 (for Ex. 3) | C | (a) | 0.25 | 10 | 2 |
| No. 4 (for Ex. 4) | F | (a) | 0.25 | 10 | 2 |
| No. 5 (for Ex. 5) | G | (a) | 0.25 | 10 | 2 |
| No. 6 (for Ex. 6) | A | (b) | 0.25 | 10 | 2 |
| No. 7 (for Ex. 7) | A | (c) | 0.25 | 10 | 2 |
| No. 8 (for Ex. 8) | A | (a) | 0.25 | 4 | 2 |
| No. 9 (for Ex. 9) | A | (a) | 0.25 | 16 | 2 |
| No. 10 (for Ex. 10) | A | (a) | 0.25 | 10 | 1.45 |
| No. 11 (for Ex. 11) | A | (a) | 0.25 | 10 | 2.55 |
| No. 12 (for Ex. 12) | A | (d) | 0.25 | 10 | 2 |
| No. 13 (for Ex. 13) | A | (e) | 0.25 | 10 | 2 |
| No. 14 (for Ex. 14) | A | (a) | 0.008 | 10 | 2 |
| No. 15 (for Ex. 15) | A | (a) | 0.52 | 10 | 2 |
| No. 16 (for Ex. 16) | A | (f) | 0.25 | 10 | 2 |
| No. 17 (for Comp. Ex. 1) | D | (a) | 0.25 | 10 | 2 |
| No. 18 (for Comp. Ex. 2) | E | (a) | 0.25 | 10 | 2 |
| No. 19 (for Comp. Ex. 3) | H | (a) | 0.25 | 10 | 2 |
| No. 20 (for Comp. Ex. 4) | I | (a) | 0.25 | 10 | 2 |

The properties of the carbon blacks A-I are shown in Table 2 below. In this regard, the carbon blacks A-I are the same (NIPEX 150 from Degussa A.G.) except that the lot numbers thereof are different from each other. Namely, the residue on sieve and the STSA of the carbon black (NIPEX 150 from Degussa A.G.) vary when the carbon black has a different lot number. In this regard, the residue on sieve and the STSA are described in the inspection data sheet attached to the product (NIPEX 150).

TABLE 2

| Carbon | Residue | |
|---|---|---|
| black | on sieve | STSA |
| used | (ppm) | (m²/g) |
| A | 25 | 80 |
| B | 0.1 | 80 |
| C | 50 | 80 |
| D | 0.08 | 80 |
| E | 52 | 80 |
| F | 25 | 70 |
| G | 25 | 90 |
| H | 25 | 68 |
| I | 25 | 92 |

The surfactants (a)-(e) are the same product (i.e., PAIONIN A-45-PN), which is a sodium salt of formalin condensate of naphthalenesulfonic acid, and the total content of dimers, trimers and tetramers in the formalin condensate of naphthalenesulfonic acid is shown in Table 3 below. The surfactant (f) is a polycarboxylic acid graft polymer, D-735 from Chukyo Yushi Co., Ltd.

TABLE 3

| Surfactant used (i.e., | Total content of dimers, |
|---|---|
| sodium salt of formalin | trimers and tetramers |
| condensate of | in the formalin condensate of |
| naphthalenesulfonic acid) | naphthalenesulfonic acid |
| (a) | 50 |
| (b) | 20 |
| (c) | 80 |
| (d) | 19 |
| (e) | 81 |

In this regard, the content of dimers, trimers and tetramers in the formalin condensate of naphthalenesulfonic acid is measured with the following gel permeation chromatography (GPC).

The GPC is called as size exclusion chromatography (SEC) which separates a mixture of materials having different molecular sizes in descending order using fine pores of a filler used as a stationary phase. Specifically, relatively large molecules hardly permeate the pores of the filler and are therefore moved through the column relatively quickly compared to small molecules. Thus, materials can be separated based on the molecular size thereof. In addition, the concentration thereof (distribution of the molecules) can be determined by measuring the difference between the refractive indexes of a solution and the solvent, or by analyzing the UV absorption of a functional group of the materials.

The results of the GPC method are obtained as relative values, because the values change depending on the analyzing conditions. Specifically, the analysis is performed while properly setting the conditions. Several examples of the conditions are described in the following table.

| | Column | | Molecular | | Examples of |
|---|---|---|---|---|---|
| | (series of three | Temperature | standard | | samples to be |
| Eluant | columns) | (° C.) | substance | Salt | analyzed |
| Tetrahydrofuran | KF-806L | 40 | Polystyrene | — | Polycarbonate |
| (THF) | | | | | |
| Chloroform | K-806L | 35 | Polystyrene | — | Polylactic |
| | | | | | acid |
| Toluene | LF-804 | 50 | Polystyrene | — | Silicone |
| Dimethylformamide | KD-802 | 50 | Polyethylene | LiBr | Polyether |
| (DMF) | KD-806(2) | | glycol | (10 mM) | sulfone |
| Hexafluoroisopropanol | HFIP-803 | 40 | Polymethyl | CF₃COONa | Polyethylene |
| (HFIP) | HFIP-806M(2) | | methacrylate | (5 mM) | terephthalate, |
| | | | | | polyamide |

The most popular eluant is tetrahydrofuran, and the next is chloroform. In addition, other solvents such as toluene, DMF and HFIP can also be used as eluants. DMF is preferably used for analyzing polar polymers such as melamine resins, polyacrylonitrile, polyvinyl pyrrolidone, and polyimide. HFIP is preferably used for analyzing engineering plastics such as polyamide and PET.

The columns have their own exclusion limits (i.e., measurable maximum molecular weight), which depend on the particle size of the filler. Since the columns KF-806L (for THF) and K-806L (for chloroform) are linear columns (i.e., calibration curve has linearity in a wide range), analysis in a relatively wide molecular weight range of from low molecular weight to high molecular weight can be performed. It is possible to use a column (806 series) for high molecular weight and another column (802 or 803 series) for low molecular weight.

### Examples 1-16 and Comparative Examples 1-4

### Preparation of Ink

The following components were mixed and agitated for 30 minutes, and the mixture was subjected to filtering using a membrane filter, followed by vacuum deaeration.

| | |
|---|---|
| Carbon black dispersion | 40.0 parts |
| (pigment content of 20%) | |
| Glycerin | 20.0 parts |
| Diethylene glycol | 10.0 parts |
| 2-ethyl-1,3-hexanediol | 3.0 parts |
| 2-pyrrolidone | 3.0 parts |
| Anionic emulsion of self-emulsifying | 2.0 parts |
| ether-based polyurethane resin | |
| (W5025 from Mitsui Chemicals | |
| Polyurethanes, Inc.) | |
| Distilled water | 22.0 parts |

Thus, inks of Examples 1-16 and inks of Comparative Examples 1-4 were prepared.

### Example 17

The procedure for preparation of the ink of Example 1 was repeated except that the polyurethane resin emulsion was replaced with 2.0 parts of a styrene-acrylic aqueous emulsion (J840 from BASF).

Thus, an ink of Example 17 was prepared.

### Example 18

The procedure for preparation of the ink of Example 1 was repeated except that the polyurethane resin emulsion was replaced with 2.0 parts of distilled water.

Thus, an ink of Example 18 was prepared.

The thus prepared inks of Examples 1-18 and Comparative Examples 1-4 were evaluated with respect to the following properties.

### 1. Image Density of Recorded Image

The ink was contained in an ink pack of the ink cartridge of an inkjet printer, IPSIO GX 5000 manufactured by Ricoh Co., Ltd., and the ink cartridge was set in the inkjet printer.

The inkjet printer was operated to form an image on a plain paper XEROX 4200 from Xerox Corporation. The image density of the recorded image was measured with a densitometer from X-rite Inc.

The image density property was classified as follows.

◯: The image density is not lower than 1.30. (Good)
Δ: The image density is not lower than 1.20 and lower than 1.30. (Acceptable)
X: The image density is lower than 1.20. (Bad)

### 2. Ejection Property of Ink

Twenty (20) copies of an original image having an image area proportion of 5% were continuously produced by the above-mentioned inkjet printer, in which the ink cartridge is set, under an environmental condition of 32° C. and 30% RH, and then the copying operation was stopped for 20 minutes. After this image forming operation followed by the 20-minute pause was repeated 50 times to produce 1,000 copies, the nozzles of the recording head were observed with a microscope to determine whether the ink is fixedly adhered thereto.

In this regard, the recording conditions of the printer were as follows.

Duty for ink: 100%

Record density: 300 dpi

Recording method: One-pass recording method (recording is performed only when the recording head is moved forward)

The ejection property was classified as follows.

◯: The ink is not fixed to the vicinity the nozzles. (Good)
Δ: The ink is slightly fixed to the vicinity of the nozzles. (Acceptable)
X: The ink is seriously fixed to the vicinity of the nozzles. (Bad)

### 3. Preservability of Ink

After the viscosity of the ink was measured, the ink was contained in a polyethylene container and the container was sealed. The sealed container was allowed to settle for 3 weeks in a chamber heated to 70° C. After the preservation test, the viscosity of the ink was measured again to determine the change rate of the viscosity.

The preservability was classified as follows.

◯: The change rate of viscosity is within 10%. (Good)
Δ: The change rate of viscosity is greater than 10% and less than 30%. (Acceptable)
X: The change rate of viscosity is greater than 30%. (Bad)

The evaluation results are shown in Table 4 below.

TABLE 4

| | Image | Ejection | |
|---|---|---|---|
| Ink | density | property | Preservability |
| Example 1 | ◯ | ◯ | ◯ |
| Example 2 | ◯ | ◯ | ◯ |
| Example 3 | ◯ | ◯ | ◯ |
| Example 4 | ◯ | ◯ | ◯ |
| Example 5 | ◯ | ◯ | ◯ |
| Example 6 | ◯ | ◯ | ◯ |
| Example 7 | ◯ | ◯ | ◯ |
| Example 8 | ◯ | ◯ | Δ |
| Example 9 | ◯ | ◯ | Δ |
| Example 10 | Δ | ◯ | ◯ |
| Example 11 | ◯ | ◯ | Δ |
| Example 12 | ◯ | ◯ | Δ |
| Example 13 | ◯ | ◯ | Δ |
| Example 14 | ◯ | ◯ | Δ |
| Example 15 | ◯ | Δ | ◯ |
| Example 16 | Δ | ◯ | ◯ |
| Example 17 | ◯ | ◯ | Δ |
| Example 18 | ◯ | ◯ | Δ |
| Comparative | X | X | Δ |
| Example 1 | | | |
| Comparative | Δ | Δ | X |
| Example 2 | | | |
| Comparative | X | Δ | Δ |
| Example 3 | | | |
| Comparative | ◯ | Δ | X |
| Example 4 | | | |

It is clear from Table 4 that the inkjet ink of the present invention has a good combination of ejection property and preservability and can produce images with high image density for a long period of time without causing the nozzle clogging problem.

Additional modifications and variations of the present invention are possible in light of the above teachings. It is therefore to be understood that within the scope of the appended claims the invention may be practiced other than as specifically described herein.

What is claimed is:

1. An inkjet ink comprising:
a carbon black having a residue on sieve of from 0.1 ppm to 50 ppm, which is determined based on DIN ISO 787/18, and a statistical thickness surface area (STSA) of from 70 m²/g to 90 m²/g;
a surfactant;
water; and
a water soluble organic solvent.

2. The inkjet ink according to claim 1, wherein the surfactant includes a sodium salt of formalin condensate of naphthalenesulfonic acid in which a total content of dimers, trimers and tetramers of naphthalenesulfonic acid is from 20% to 80% by weight based on a total weight of the formalin condensate of naphthalenesulfonic acid, and wherein a weight ratio (S/C) of the sodium salt of formalin condensate of naphthalenesulfonic acid (S) to the carbon black (C) is from 0.01/1 to 0.5/1.

3. The inkjet ink according to claim 1, further comprising:
an anionic emulsion of a self-emulsifying ether-based polyurethane resin.

4. A method for preparing the inkjet ink according to claim 1, comprising:
mixing at least the carbon black, the surfactant, and water to prepare a mixture having a viscosity of from 5 mPa·s to 15 mPa·s;
subjecting the mixture to a dispersing treatment using a media-mill to prepare a carbon black dispersion having a viscosity of from 1.5 mPa·s to 2.5 mPa·s; and
mixing the carbon black dispersion and the water-soluble organic solvent.

5. An ink cartridge comprising:
the inkjet ink according to claim 1; and
a container containing the inkjet ink therein.

6. An image forming apparatus comprising:
the ink cartridge according to claim 5; and
a recording head to eject droplets of the inkjet ink in the ink cartridge toward a recording material to form an image on the recording material.

7. An image forming method comprising:
ejecting droplets of the inkjet ink according to claim 1 toward a recording material to form an image on the recording material.

8. A print comprising:
a support; and
an image formed on the support by the image forming method according to claim 7.
